(19) United States
(12) Patent Application Publication
(10) Pub. No.: US 2021/0110492 A1
(43) Pub. Date: Apr. 15, 2021

(54) SYSTEM AND METHOD FOR CREATING OR PROCESSING A NEW DATA RECORD ASSOCIATED WITH INVENORSHIP VALUE

(71) Applicant: Cheryl Milone COWLES, New Smyrna Beach, FL (US)

(72) Inventor: Cheryl Milone COWLES, New Smyrna Beach, FL (US)

(21) Appl. No.: 17/067,552

(22) Filed: Oct. 9, 2020

Related U.S. Application Data
(60) Provisional application No. 62/913,049, filed on Oct. 9, 2019.

(51) Int. Cl. G06Q 50/18; H04L 9/06; G06Q 40/06

(52) U.S. Cl. CPC G06Q 50/184; H04L 2209/38; G06Q 40/06; H04L 9/0618

(57) ABSTRACT

Inventorship Value may be generated and associated with a new data record that may run with an inventor(s) of a patent independently of ownership of the patent. The inventorship value is based upon any of a number of factors, such as an inventors contribution to the state of the art, meeting inventor metrics, financial contributions of the inventor's work, value of created intellectual property, an economic impact on an inventor's employer, a valuation of the patent, or some other tangible benefit as a result of the inventor's past, present, or future work. The inventorship value may inure to the benefit of the inventor independently of patent ownership or subsequent assignments.

### CROSS-REFERENCE TO RELATED APPLICATIONS

This application claims the benefit of U.S. Provisional Application No. 62/913,049, filed Oct. 9, 2019, the contents of which are incorporated herein by reference in its entirety.

### BACKGROUND

The field of the present disclosure is related to creating, processing, tracking, updating, and quantifying a new data record associated with inventorship value.

### SUMMARY

According to some embodiments, a new data record is associated with an inventorship value that may be based upon any of a number of factors, such as, but not limited to, an inventors contribution to the state of the art, meeting inventor metrics, financial contributions of the inventor's work, value of created intellectual property, an impact on an inventor's employer, or some other tangible benefit as a result of the inventor's past, present, or future work.

### INCORPORATION BY REFERENCE

All patents, applications, and publications referred to and identified herein are hereby incorporated by reference in their entirety and shall be considered fully incorporated by reference even though referred to elsewhere in the application. Specifically, the subject matter of the present application is related to and incorporates by reference the complete disclosures of the following commonly owned U.S. Patents and pending applications:

### BRIEF DESCRIPTION OF THE DRAWINGS

The accompanying drawings are part of the disclosure and are incorporated into the present specification. The drawings illustrate examples of embodiments of the disclosure and, in conjunction with the description and claims, serve to explain, at least in part, various principles, features, or aspects of the disclosure. Certain embodiments of the disclosure are described more fully below with reference to the accompanying drawings. However, various aspects of the disclosure may be implemented in many different forms and should not be construed as being limited to the implementations set forth herein. Like numbers refer to like elements, but not necessarily the same or identical elements throughout.

FIG. 1 illustrates a computing environment in which inventorship value is an agglomerated result of numerous inputs, in accordance with some embodiments;

FIG. 2 illustrates an example architecture of computing resources having access to a new data record inventorship value, in accordance with some embodiments;

FIG. 3 illustrates an example process flow diagram showing a method of determining an inventorship value record; and

FIG. 4 illustrates an example process flow showing a method of determining an inventorship value record.

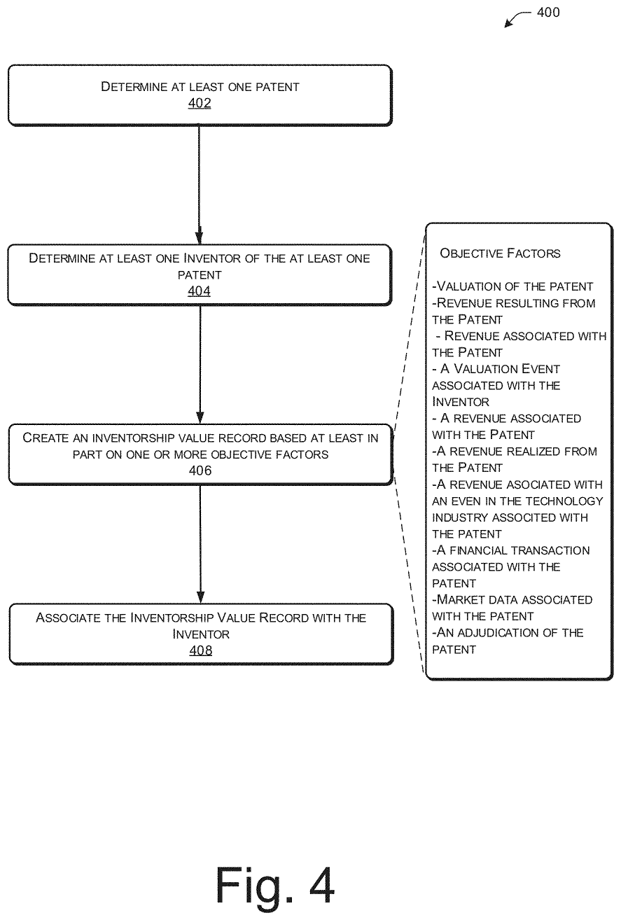

### DETAILED DESCRIPTION

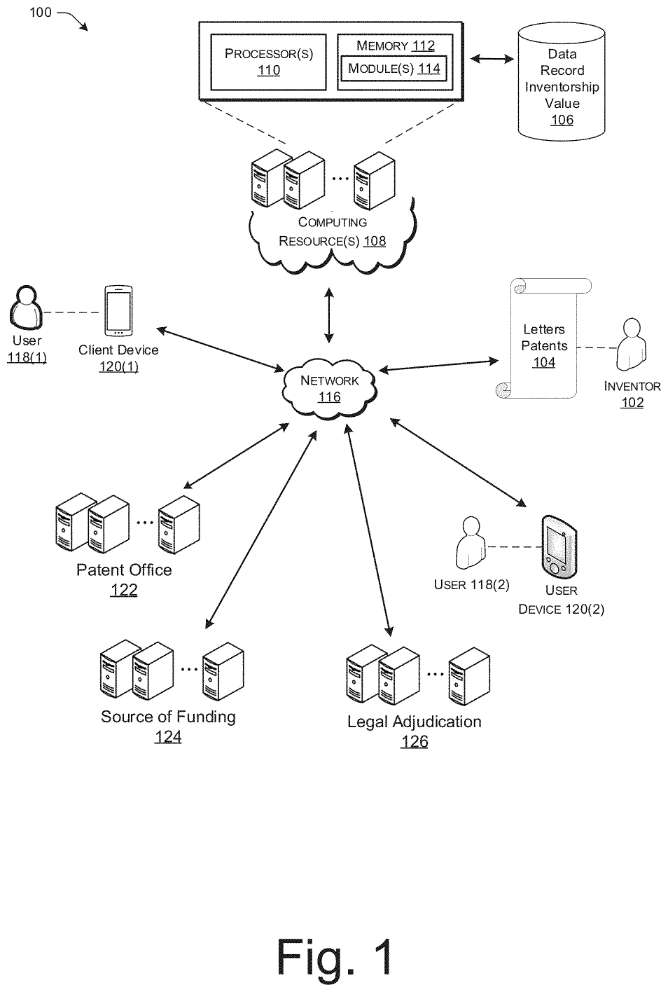

With reference to FIG. 1, a system architecture 100 is illustrated according to some embodiments of the invention, in which a new data record represents a value associated with an inventor 102 of a patent 104 (“inventorship value”). The new data record may also be associated with the patent 104 for the benefit of the inventor 102. In one example, the new data record inventorship value 106 may be related to any information, data field(s) or database which is associated with an inventor of one or more patents. The inventorship value may be expressed as a financial value, in one example, a current value, or an approach for calculating a current or future value.

Where an inventor 102 does not assign her rights, she maintains ownership of the patents 104 and has a value associated with ownership rights. Where the inventor assigns her rights, and therefore becomes an assignee, then her ownership rights may change under current United States (US) statutory and contract law (and likely in international jurisdictions as well).

The new data record inventorship value 106 is at least in part independent of the ownership value of the patent, regardless of whether the inventor assigns her rights or not. In one example, the inventorship value is at least in part separate from ownership value so that the change in ownership need not impact the inventorship value. Regardless of the characterization of the value of corporate technology for patents which are assigned, the inventor of the patents for the technology retains an inventorship value which is at least in part different than traditional values of the corporate technology for patents which are assigned.

The new data record may be based on an incentive to create inventorship value for inventors where inventors assign their rights under US or international patent, contract or other laws to their employers. This is generally true in the US with US companies holding the majority of US patents today. In the US, statutory and contract law (such as the Uniform Commercial Code (the UCC) or state laws, generally govern rights and obligations regarding patents, including as between inventor(s) and other stakeholders (such as entities which employ the inventor and to whom the inventor is obligated to assign the patent). Laws and precedent under international jurisdictions can be evaluated for their respective approaches. As a result, under standard agreements, such as employment agreements, work-for-hire terms, assignment agreements or provisions, inventors relinquish ownership of the patents and with it, at least a portion or all of, the financial value associated with the patent asset.

The architecture 100 further includes computing resources 108 that may be any suitable type of computing resources, and may include distributed computing resources, one or more server computers, or cloud computing resources. The computing resources may have one or more processors 110, suitable memory 112, and instructions stored in the memory as modules 114 that may be executed by the one or more processors 110.

The computing resources 108 may be coupled to a network 116, such as the internet, via any suitable wired or wireless connection and have the ability to send and receive data to and from other computing devices. For example, the computing resources 108 may be able to send and/or receive data from one or more users 118(1), 118(2), and user devices 120(1), 120(2). In addition, data may be shared with one or more patent offices 122, one or more sources of funding 124, and one or more sources associated with legal adjudication 126. In some cases, these one or more sources of information may contribute data that is used to affect or influence the new data record associated with inventorship value 106

In another example, the new data record 106 may represent a separate inventorship value for a correlation between the inventor 102 and value related to the patent 104, which is outside of the general benefits and liabilities of the inventor and stakeholders in the patent under existing laws. The inventorship value may be correlated to the inventor outside of the interest currently provided for under US law for the inventor as an owner and subsequent owners, such as an assignee to whom the inventor assigns the patents and future assignees which may receive the patent through future transfers or other transactions.

In another examples, the new data record 106 generates a new interest for the inventor 102, which is separate at least in part from the traditional ownership value in the patent. The new interest is the inventorship value 106. In other examples, the inventorship value may be the same as the traditional ownership value. Where the inventor 102 assigns her rights, her ownership value is extinguished, but the new data record of the inventorship value is still available to provide a separate value. The inventorship value may be provided by a stakeholder in the patent, such as the assignee or entity with an association with the patent or the assignee, such as an investor. The inventorship value also may be provided by a party which has no interest in the patent, individuals or entities associated with the patent. Examples of inventorship value are $100, $500, $1000 per patent, a multiplier where the inventor holds additional patents, a present value calculation or an expected valuation as a function of a market assessment of patents generally, an assessment of patent assets in their industry sector or technology area, milestones related to the patent such as commercialization gross or net margins, EBITDA, litigation or US post-grant successes and damages or royalty results, or contribution or use in a merger and acquisition transactions, etc.

In this way, stakeholders in the patent system, by contributing to innovation and advancement of innovation and science, or to commercializing lines of business or other innovation or business objectives, may receive financial value from their contributions regardless of the current state of government, legislative, administrative, executive or other orders or contract laws from any jurisdiction where they otherwise may assign their rights to another party. In this manner, inventors, innovators, scientists, engineers with continued ownership have a new data record of inventorship value added to their benefits. In addition, inventors, innovators, scientists, engineers who have assigned their ownership may be reconnected with the value they have created through their innovations. New potential entrants in innovation also may be incentivized to focus for on patenting due to the increased recognition and potential remuneration.

Calculating the Financial Metric for the Inventorship Value

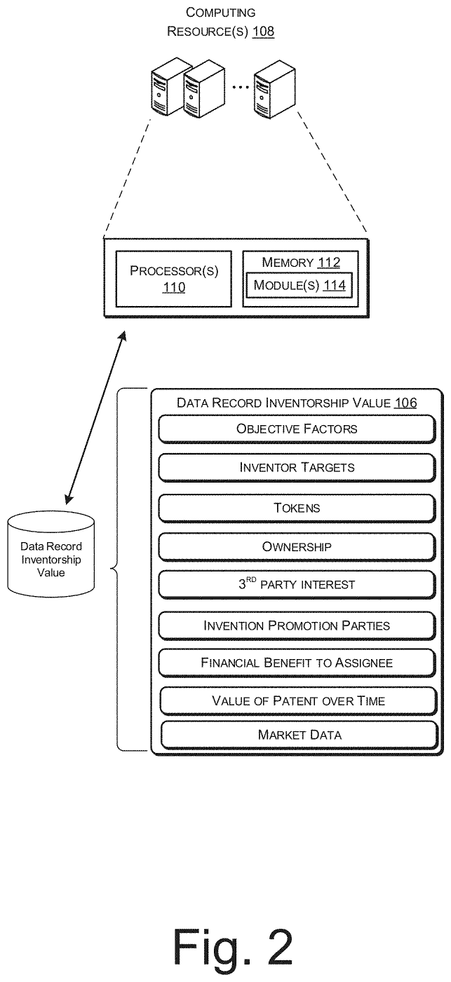

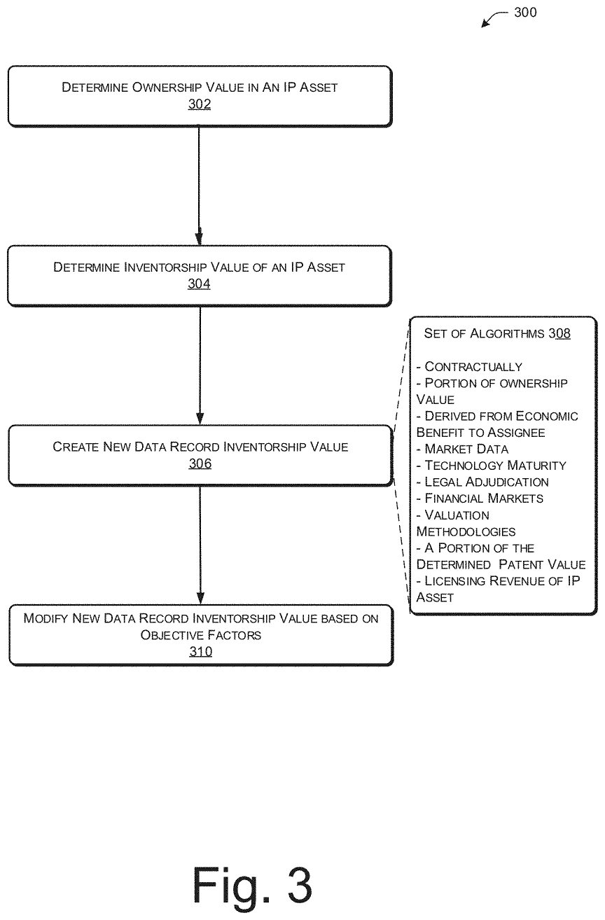

With Reference to FIGS. 2 and 3, there are a number of ways to determine the inventorship value as a financial metric 400. Any of the examples herein may be executed separately, or one example may be combined with another example herein, and a range of examples for calculating inventorship value may be applied for any stakeholder, including inventors, corporate assignees, or any third parties which have a formal or contractual interest (e.g., a financing entity or insurance company, or a bankruptcy-related entity) or which do not have contractual or other formal interests direction in the patent (for example, patent offices, governments or administrative parties seeking to promote invention; a private business which provides services, for example, paying renewal fees, with a portion of the gross or net margin going towards a fund for an inventorship value financial metric.

At block 302, in general, the calculation of a financial value of an asset is known, including as one example, the valuation of a patent, as is discussed further elsewhere herein. At block 304, the inventorship value may be based on a portion of or a duplication of the ownership value, or the inventorship value may be derived from the ownership value. There are multiple approaches to determine financial value, as shown by the attached list of articles on the topic.

For example, the following article addresses patent valuation and is incorporated herein in this application by reference and included in full text found at https://en.wikipedia.org/wiki/Patent_valuation. In addition, each approach presented individually or in combination in this document publication may be combined with any other individual or combination of approaches in this application or as is known as of the filing date of this application by those of ordinary skill in the art.

As a result, the total of the inventorship value and ownership value may be greater than the historic ownership value associated with a patent, and the inventorship value may be different than the ownership value. In addition, in some examples, the inventorship value and ownership value may be provided by different sources, such as the assignee company for the ownership value and a third party for the inventorship value. In this example, the financial metric for the ownership value is from the traditional source such as the corporate assignee of the patent. For the inventorship value, the third party may be different from the corporate assignee, and the third party may choose to calculate inventorship value using traditional financial metrics or may choose a different approach. The third party is not limited to traditional financial metrics or approaches used to arrive at them.

At block 306, a new data record inventorship value may be created. For example, the new data record inventorship value may be predetermined as a function of value received through a number of different measures of value of the patent an algorithm 308 taking into account changes to the value of the patent as recognized over time, or at least in part the valuation applied to assets related to the patent, such as the company or stakeholders which own(s) the patent, or technology areas related to the patent. The inventorship value may also be determined in part based on changes in the value of the patent, the inventor, other inventors associated with the patent, the company, the companies' competitors, the companies' technology area, market data, entities associated with the company (such as standard bodies), entities which evaluate the patent or company such as adjudicative bodies (legal and legislative, etc.) or financial markets (such as the NASDAQ or S&P etc.), data analytics entities, etc.

In further examples, the inventorship value as a financial value may be a partial or full amount of a financial valuation associated with the patent at the time the inventorship value is assigned (or related events such as the filing or priority date of the patent, and in some cases where the patent is meets statutory requirements, the conception and/or reduction to practice dates), a family of patents to which the patent is related and/or a portion or all of the patents related to an entity (such as the assignee or owner of the patent), a portion of all of the patents related to the subject matter of the patents (such as, in one example, the class and sub-class or art unit assigned to the patent by the US Patent and Trademark Office “USPTO”). The financial valuation may also be based on market data about the patent or associated patents. Market data which may determine the financial value of a patent or associated patents further may be generated based on a litigation outcome, financing or other due diligence activity related to the patent or relevant technology for financial valuation. Financial value may also be calculated using subsequent assignments of the patent or technology, licensing agreements, inclusion in standard organizations, court cases, data extrapolated from other licensing agreements and/or a generation of financial value based on market data from public or private entities engaged in providing valuation for patents or inventors as the source of patents.

Further bases for financial value may include: a current or future monetary amount or percentage based on a financial amount associated with the patent, such as a current valuation or future valuation established by a legally binding agreement between one of the owner or assignee of the patent and a third party, a financing party for the patent, an agreement between parties or a third party opinion regarding a financial transaction for the patent, an outcome of a proceeding whether in the public sector (litigation, USPTO PTAB, ITC or foreign jurisdiction), an arbitration or mediation, data provided about the patent or similar patents by standard settings bodies, and/or a financial entity which values the technology for litigation financing or providing a loan where the financial entity holds the patent as at least in part or whole of the collateral for the financing, another financial transaction or an insurance entity decision for offensive or defensive insurance policies. The financial value associated with the patent may further include a percentage of the monetary amount determined by the company to represent the value of the patent or contributions by the inventor, including, for example, equity or options granted, portions of equity or options or another representation of current or future potential financial value. The financial value may alternatively or in addition relate to the valuation of the assignee company of the patent(s). There have been many examples of how to calculate financial value herein and the stakeholders or third parties which may undertake that assessment herein (and in the attached articles). Any of the examples herein (and in the articles), may be implemented individually or in combination and by any individual or combination of stakeholders.

Inventorship Value based on Objective Factors

At block 310, In some examples, the inventorship value also may be determined by relying on objective statistics related to patents or IP programs. Objective factors may include: the number of patents for which the inventor is listed as an inventor; grants or awards made to the inventor or related company; participation on a platform regarding individual patents, technologies or associated patents; or, individual or societal causes. One example of societal causes may be the inventor's citizenship in a nation-state, the jurisdictional basis of the patent such as all US patents, or patents initially filed in countries other than the US, or patents which have a family patent or application in a given or a group countr(ies), or applied for under a treaty, such as the PCT. One might imagine originating countries (such as the US, EU or China et al.) incentivizing inventors and owners of patents in their jurisdictions to file internationally outside of the initial jurisdictions.

An inventor may also receive a monetary amount for financial outcomes associated with the patent, such as a percentage of the financial outcome associated with an event related to the patent. For example, such an event may be based on a patent sale, with a percentage of the financial outcome being provided to the inventor, such as a 1% of the transaction up to a cap, such as $10,000. In another example, an inventorship value awarded to an inventor for her inventive or scientific activities generally, and an accumulation of awards (or a series of values for the accumulation of multiple activities) may then be used to calculate a financial outcome. One example is an increased return for an increasing number of multiple patents. More particularly, for each patent filed by an inventor, within a technology subject area, or generally, the inventorship value associated with the inventor or the percentage of a financial outcome may increase. In the example above, a 1% fee from the transaction may increase where the inventor has received multiple patents within the same technology area or for the same company or assignee, or total regardless of the technology area or company/assignee. One exemplary increase is 0.25% per additional patent to an inventor with multiple patents and/or 0.25% (or alternatively, 1%, 2% etc.) increases based on each of individual patents, or for multiple patents, or an increasing level depending upon the number of multiple patents (such as a target of 3, 5, 7, 12, a range of 3-6 etc. patents with an increasing amount as a function of the number of patents, versus two patents for the minimal increase), patents in different technology areas, patent publications, peer-reviewed publications, published white papers, award-winning publications or other awards or industry recognition (e.g., inventorship awards, a member of the Academy of Sciences, National Academy of Inventors, United Inventors Association or other top US inventor groups, such as Inventor Halls of Fame, the Inventors Groups of America, etc.), or any combination of any of the above examples.

Source of Funds for Distribution of Inventorship Value

A fund may be created to finance inventorship value based on data records of the financial metrics for inventorship value. Inventors may then receive a pro-rata share of an identified measure of financial value from the fund. The inventor's share may be based on patents attributable to the inventor, related patents, or families (such as family size) or groupings of patents or technology subject matters. The inventor can accumulate rewards which may be compensated as a pro-rata share of the identified measure of financial value provided by the fund. For example, each patent may be assigned a financial value of $100, $500, $1000, $10,000, $100,000, $250,000 (or another predetermined value or a value which is at least partially dependent upon related values such as corporate valuation or a transaction valuation etc. based on any of the examples herein) as the inventorship value of each of the new data records. The fund may be valued at with a total value (such as $100,000, $1MM or $10MM), which may be equally divided among patents, inventors, USPTO classifications, art units, technology subject matter, jurisdictions, family size, etc. Alternatively, the inventorship value can be multiplied by the number of total patents invented by a given inventor or for particularly valuable technology areas.

In another example, a corporation may designate a percentage of its stock financial value or options based on inventorship to fund an inventorship value for inventors, in addition to the benefits inventors receive under traditional approaches and current US and international laws. The inventor may, as a result, receive a percentage of inventorship value from the options based on the inventor's number of patents or other indicia of inventorship including any of the descriptions of the examples herein.

Sources of Funding for Inventorship Value

In another example, the incentives may be provided to inventors separate and apart from owners of the patents, whether the owner is the inventor, or a company which receives the patent by assignment. In one example, the incentivizing entity is the organizer of a global platform of the world's patents. The incentives in this example may come from an entity which has a reduced or no formal interest (such as contractual, statutory, legislative or administrative) in the patents. The entity in this case may provide the incentive without regard to the assignment of rights to their patents or involvement or sanction of the assignee in the generation of a separate incentive. The source of the incentive may also be separate and independent of the patent owner, related corporation or stakeholders with a statutory, administrative or contractual or other formal interest in the patent. One such entity is an independent third party, for example, the originator or source of a platform. The incentive may be provided and managed on the platform (for example, through an Internet platform and community which includes inventors, scientists, technologists generally or within technology subject matter or jurisdictions), organization, or repository, or even an individual interested in promoting patents, separate and independent of the ownership or formal or statutory or contractual interest in the patent. One example is a patent office or governmental body seeking to incentivize inventors by providing a separate recognition of inventorship. The incentive also may be separate and independent of, or partially dependent on, activities regarding the patent, the patent inventor, owner or third party. The platform may include a traditional identifier for patents, such as one or more of an identifying citation (e.g., one or multiple of the patent number, patent application number, publication number, etc.), country of filing, family data, owner, inventor, classification, inventor, etc.

The assessment and distribution of inventorship value by a third party with reduced or no formal contractual interest in the patent further supports an industry, governmental or societal encouragement of invention. Inventors generally have received financial value and recognition through historical statutes and private contracts, and those sources reduce or diminish the inventor's financial interest upon assignment. An assignment also may result in reducing or discontinuing notice or information about the patent, thereby reducing recognition. Where a separate entity from a current assignee, or stakeholder with an interest in the patent, continues to recognize financial value for the inventor in the form of the inventorship value, inventors receive reinforcement of their natural interest in invention. The inventorship value financial component, the marketing of it and other recognition of the inventor (including non-financial recognition such as a published acknowledgment) continue to provide significant recognition as well.

Inventorship Value based on Activities of the Inventor

The third-party provider, such as a platform, of inventorship value may apply one or more bases to determine or accumulate the inventorship value. The inventorship value may be determined based on activities of inventors regarding their patents or company which the inventor and/or patent benefits. Activities related to the inventors may include filing for patent applications, receiving patents, preparing scientific publications, assessing data on the global platform, such as the quality of patents in their technology area, contributing to the success or growth of the global platform and the activities associated with it. Each activity or a series of activities may trigger a predetermined or a range of value(s) for one or more data records becoming available to an inventor.

Additional examples of activities are as follows: activities regarding the inventor, his or her patents, the inventor's association with the global platform, his contributions to innovation, the patent system, the global platform, or its profits; activities which are separate and apart and without any association of the global platform, but derived from his or her inventorship, innovation or scientific activities (for example, receiving a STEM degree in college). The new data record may be associated with the global platform to represent value and/or accumulate value over time.

Inventorship Value Based on Activities or Objectives of Sources of Funding

Other activities may initiate the value transfer, such as activity associated with the manager of the global platform (for example, an annual distribution or financial outcome to the inventors associated with the new data record), an accumulation of activities or the completion of an objective or predetermined milestone for the platform, such as inventors interacting with the platform to “claim,” validate or acknowledge their inventorship value record. Further examples are one or more valuation events based on sales or licensing transactions for the patent, related patents, technology area, inventor, related inventors, company associated with patent(s) or inventor(s). In another example, the inventorship value is a pooled fund representing inventorship value generally for all or a subset of patents (e.g., US). On a systematic basis annually, such as quarterly, semi-annually, annually, etc., the pool is distributed to inventors as a function at least in part of the success or profits of the platform.

Notice Function to Inventors of the Inventorship Value

An additional component of the new data record, or a separate notice record, may be generated, including notice of activities for the patent to the inventor regarding her invention. Where notice is a separate record, it may be used in combination with a new data record of inventorship value, or the newly generated data records may be used independently of one another. The existence of patents and data associated with patents, as well as communications with the USPTO during prosecution before a publication of the patent application, remain secret. Even after publication, developments with the patent, such as issuance, subsequent assignment changes, use of the patent as an asset and other benefits that may derive from patent assets in industry, may not be recorded or even where recorded, may not be communicated to inventors due to an assignment where notice goes to current owners/assignees.

Notice As a New Data Record/Changes to Computer Processing based on the New Data Record of Inventorship Value

In one example, where a database contains patents and for each patent, the new data record for inventorship value is included, inventors of the listed patents may receive a financial value based on new processing. These new data records change the functioning of a computer by introducing notice to inventors of the existence of inventorship value or their separate benefit and the communications that may be initiated because of these separate benefits. Inventors may also have an opportunity to add information relative to the patent. The notice data record may prompt the inventor to engage with the platform. The inventor may be prompted to provide information related to the patent based on the notice data record and/or inventorship value data record. For example, the inventor may add new information to the platform in the event of an activity, such as litigation or a transaction, regarding the patent to support the validity of the patent. The inventor may also be given an opportunity to provide an affidavit or evidence or data to support a defense of the patent in a proceeding such as an Inter Partes Review. The additional information then may contribute to assessing the financial valuation of the patent or related company and may result in an increase in inventorship value.

Execution of the New Data Record Inventorship Value in Tokens

The new data record in some examples may be implemented as a token or another form of data record stored in a database. A token may be implemented in a blockchain or distributed network system. The new data record of inventorship value presented as a token may be associated with the inventors of patents. In one example with tokens to implement inventorship value, upon a financial event regarding the patent, the token may be converted to a final metric awarded for distribution, the inventor as the beneficiary. For example, a company may want to offer an incentive to its employees to increase their inventive activities. The company therefore may pledge that while the inventors assign their patent applications, thereby foregoing a direct financial interest, a financial value is assigned to the patents, such as $1000 in a token account (or alternative account or fund) which will remain with the patent regardless of changes in ownership. In another example, to the extent at a future date, a valuation is set or derived for the patent, such as the $500 per patent, the $500 or a different amount tied to the valuation of the patent may be provided as inventorship value. Additional exemplary financial metrics are as follows: $1,000, $5,000, a range of $5,000-$25,000, $1MM, $2MM+etc. Additional examples of the inventorship value may be based on the valuations, or another success metric of the company, such a valuation of the company upon a sale. The financial interest may be formalized in the token new data record or other account to benefit the inventor. Using tokens in one example, they or a third party may be separate and apart from historic incentive structures. The company may separately fund the tokens. The funding of an account may be part of the capital structure of the company, but the new data record represents a new approach to providing inventorship value to inventors regardless of historical approaches. In the token or account approach, in order to be granted or assigned a token, the inventor may have to relinquish other potential rights or benefits that may be associated with maintaining an interest, such as input about transactions regarding the patent, or approval or ability to limit or control transfer or use of the patent. In one example, the creation of a token and inventorship value to inventors does not impact clear title and autonomy over the patent by the assignee once the patent has been assigned. The obligations along with the benefits of the inventor in recognizing inventorship value may be formalized contractually in receiving tokens.

In another example, a platform (such as a platform presenting a database with a set of patents, by company, subject matter, classification codes, national filings, with associated families, or any metric by which to identify the patents, may associate a token with each inventor, patent, set of patents (according to any identity or breakdown for the inventor, for the class/subclass, technology area etc., as described above), or associated components of value, such as awards won by the inventor or the company. In additional examples, multiple tokens may be assigned to patents for additional components of value, such as know-how, consulting that the inventor offers and other indicia of value. Each of individual token may serve different incentives, for example, one token may represent inventorship with an inventorship value, another may represent associated publications, know-how or other areas of value or support to the patent. In other examples, a single token may represent an accumulation of value from multiple bases. One benefit of assigning tokens to inventors who no longer have legal ownership of the patents is to bring the inventors back into the patent ecosystem and more widely distribute the value, financial or otherwise, of patent filing, development and monetization to a broader set of stakeholders.

Companies similarly can participate in funding a third-party platform which provides inventorship value. In one example, companies can provide funding by investing in the fund to represent inventorship value generally or for their company or another category of patents, or by purchasing tokens on the platform to retroactively provide a benefit to historic inventors at their company or who have assigned their rights thus serving as a form of recognizing inventors from their patented inventions. The company can also provide tokens on an ongoing basis for future inventions. For example, when a company launches an IPO, tokens or a fund can be in part or fully funded by the company or paid to inventors with a recognition of the contribution to the success of the company. The third-party platform can facilitate this benefit supported by the company for its inventors, or the third-party platform can provide new data records or tokens of inventorship value separately.

The company also can independently establish a set of tokens or another funding mechanism which includes a representation of the current or future inventorship value of a patent as a data record within a database about one or more patents. The patents may include patent which have been assigned, including financial benefit of the patent application, a patent which issues therefrom or subsequent applications and/or patents. The patents referenced by the data records or tokens in the database may also include those where there is no assignment such that the inventor maintains ownership rights under patent laws in the United States. For tokens associated with a patent, a financial value as the inventorship value associated with the inventor of a patent regardless of whether or not the inventor has partially or fully assigned her rights to the patent. Upon the establishment of financial value for the patent, the token for financial value for the inventor may change to reflect a portion (or in another example, the full) financial value. In this manner, even where an inventor has assigned her rights to an assignee, including forgoing full or partial financial value for the patent, the new data record produces an association of inventorship value for the inventor with the patent once again in the form of a financial value.

Where the inventor has not assigned her rights, the value of the token as inventorship value may be separate and beyond a financial value or other benefits of continued ownership. Upon a financial value being established for the patent, the token for inventorship value for the inventor may change to reflect a portion of (or in another example, the full) the financial value. In this manner, even where an inventor has assigned her rights to an assignee, including forgoing full or partial financial value for the patent, the new data record produces an association of the inventor with the patent once again based on financial value. In another example, the new data record represents a separate value, such as financial value, even where the inventor does not assign his patent rights and, thereby, retains ownership rights. The token value is then in addition to any value derived from continuing ownership of the patent by the inventor. Where assignment is applicable, inventors of patents in settings where their employment requires assignments, now have an opportunity to participate in financial outcomes for the patent. This reinvigorates the policy of the patent system to promote benefits for inventors in an environment where inventorship generally is deemed to be compensated as part of employment with future financial outcomes separated from inventors and instead directed to the subsequent owners through assignments.

Use of Tokens As the New Data Record

Funding for the tokens may derive from any number of sources. The manager of a global platform may apply a portion of fees from other transactions which relate to a specific patent or patents (e.g., an individual patent or patents owned by a company) on the platform to new data records or tokens for inventorship value. For example, the manager of the platform may charge a fee for listing patents, or paying annuity fees for patents listed on the platform. The manager may give a fee reduction for the transactions and invite the patent owner to apply a portion of his savings to fund the tokens associated with the patents for which annuities are paid. The payment of an annuity represents an acknowledgment of value in the patent for the patent owner. At the same time, with the savings on the annuity fees payment, the owner can allocate a portion of the savings to tokens related to the patent. The platform manager also can assign a portion of the revenue from the annuity fees to the tokens regardless of whether the company or assignee participates. Put in another way; the platform may fund the tokens by transaction fees occurring on the platform across platform users. For example, where the platform enables a patent owner to pay annuity or maintenance fees, some of the gross or net margin on the transactions can be distributed to fund the tokens, so the platform (independent of current owners of patents) may provide funding for the tokens for inventors. The platform may then encourage the inventors by their recognition, including publicity, as stakeholders in their patents or the patent system generally. The platform also may set aside a portion of gross or net margins of the platform based on any business operations on the platform to fund the tokens. Grants can be applied for, such as federal grants to incentivize inventorship, entrepreneurship, STEM pursuits, and also for certain groups of inventors, such as veterans, women, minorities, or other groups of inventors to whom grants may apply for societal incentives.

The token system may also expand to include an association not just with inventions for inventors but tokens may separately or in addition apply to scientists, innovators, engineers or any source of innovation or know-how related to the innovation, or related technology outside of being an inventor on specific patents, whether in the utility or design patent area, copyrights, trademarks, trade dress, trade secrets or any combination of intellectual property, or other assets. In addition, tokens also may be based on individuals contributing to the creation of corporate assets or performance without necessarily being inventors of patent assets.

The tokens in the form of inventorship value or notice are new data records. In addition, the traditional data records of inventorship and ownership with a financial value associated with ownership but not inventorship generally extinguish the inventors' access to a financial outcome. As a result, the functioning of a system to record rights and liabilities for patents will be altered based on the processing of the new data record of inventorship value, or the combination of the new data records of inventorship value and notice. The separate financial value of the inventorship value will result in the computer processing a data set regarding patents differently The new data record also has a value that is defined by the implementation of the token outside and independent of ordinary contract law(s)/term(s) of assignment, employment, and work-for-hire provisions. Common data records associated with patents generally involve inventorship and ownership, and financial value is associated with ownership where the inventor is the owner, or a company which receives the patent by assignment is the owner. Also, upon a change in ownership, such as from the inventor to an assignee or from a subsequent owner to a subsequent assignee, the token for inventorship value may be established to be retained by the inventor and not transferred or associated with subsequent owners.

In still further examples, tokens may apply to historical relationships with other forms of assets. In one example, prior homeowners of homes may receive a benefit or notice that property or another asset which they previously owned is for sale, enabling them to revisit and potentially participate in the offer for purchase or sale of the asset. Alternatively, they may be a resource for current parties considering valuation for or information about the asset or simply current events about their property. Former owners also may seek other benefits (for example, posterity). In this manner, a data record representing a history of objects (such as past ownership value) can be added to the data records generally associated with assets or objects.

In another example, tokens may be established to drive any type of behavior identified by the token owner; in this way, tokens or a new data record are a new technical support record changing the processing of a computer in a manner that improves its functioning because the association of another stakeholder relative to an objective can provide additional data, recognition, contributions or benefit(s) relevant to the objective. In the case of inventors of patents, where there is a potential transaction involving the patent, the data record may serve to introduce new information relevant to the transaction, thereby creating greater and/or more accurate information for the manager of the transaction. The inventors also may be given notice of the transaction and/or be invited to weigh in about the valuation of the patents, thereby making the transaction more accurate and changing the functioning of the computer from processing the transaction to further processing of data to enhance the valuation.

The issuer of the new data records or token may also provide non-financial value as well because new data records (for example, in the form of tokens) may be issued in association with patents for non-financial objectives. An example of a societal objective for inventors is improving the participation and inventing of underrepresented veterans, women or minority inventors, etc. Using these groups for a societal objective, tokens of new data records may be granted to inventors, scientists, those who publish scientific information, who also possess the characteristics of being veterans, women or minorities, etc. The information about these classifications may be pulled from other databases or a token may be issued to inventors from whom the data is received in exchange for accumulating inventorship value in the data record. Another objective may be the tracking of an inventor's achievements generally in order to increase the inventorship value. For example, where the inventor, subsequent to the subject patent, achieves recognition for her work in the same technology subject matter, her earlier patents may be more valuable. One example is Steve Jobs' early patents, which he assigned to Apple. Where the patents were associated with a data record for Steve Jobs and a value was determined at the time, the value may be increased over time as a function of his public status and success.

New Data Records for Value Associated with Objectives

For the platform manager, additional objectives may be realized. They are, for example, encouraging individual, community, or societal activities and providing a new data record for recognition of those activities, interacting with the stakeholders holding the tokens for those activities, and ultimately assigning value for those activities separate and apart from the benefits provided under existing government laws and contract laws. Examples include filing for patents, receiving a patent, launching a business (including innovation, whether patented or retained as trade secrets), selling the business, hitting business objectives or milestones such as valuation or EBITDA targets, or any of the examples herein. The platform may recognize the overall societal value of activities, partially or fully independent from benefits between private contracting parties.

Companies may also use data records to incentivize corporate objectives, and these new records can be created at any time, including for past and future performance. Companies involved in technology and working with inventors generally have as a primary responsibility to increase investor value. Traditionally, inventors based on employment law assigned their rights to their inventions, and may also receive value in the corporation, such as through options, of increase in corporate value. As a result, historically, the contribution by the patent or patents by a specific inventor is accumulated with all other value drivers for the company.

Using the new data record enables the companies to designate a percentage of its capital structure separately for employees or contributors for a separate repository for recognition of value. For example, the company could designate 1% of its equity for the contribution from inventions shown by the assignment of patents. Another example relates to a drug company, where particular patents may provide outsized contributions to corporate income, such as a blockbuster drug. In this case, the percentage of the equity associated with a blockbuster or foundational patent can be higher than the percentage associated with other corporate patents. A separate data record, account, token or other set aside may provide the corporation with an additional approach to rewarding the inventor(s) of blockbuster or foundational patents at a higher-level than within the historic approach using assignment terms where the value of the invention may be determined early in the patent and line of business lifecycle, with greater value realized after the assignment date. This separate record also may allow events, such as a drug associated with a patent which becomes a blockbuster drug to trigger value so that the inventors have a continuing direct benefit from their building a corporate asset which generates income for the corporation or with enhanced income realized later in time. A similar approach may be taken for other activities which the corporation wants to recognize and incentivize its employees to undertake. Activities even within operational or human resources objectives (i.e., diversity goals, such as an increase in attendance and positive feedback about HR programs and a decrease in HR filings), such as the ranking of employee excellence, customer service, reviews by peers, or actions which give employees a more direct recognition and value based on predetermined objectives and acknowledge employees' breakthrough success on such objectives directly or in comparing employees relative to each other. In this way, employees who may not have compensation terms which give access to returns that may generally be available for higher level inventors or upper-level management have opportunity to receive a greater share of the corporate value based on their contributions relative to their peers in the corporation.

In another example, the inventor or scientist may be allowed to participate in the platform based upon a qualifying activity, such as filing for a patent or publishing a scientific paper. The manager of the platform may also choose to require the inventor to pay a fee in order to receive the data record or token, so there is an acknowledgment of value from the inventor as well. This may support a reduction in misuse or abuse of the platform and also provide funding activities related to the operation of the platform directed to the new data records or tokens. Other acknowledgments of value for the new data records or tokens may be other contributions to the platform, such as sponsorship of the platform through public or social media marketing, participating in committees on the platform to ensure proper distribution of new data records and tokens, training of inventors, and efforts which build the value of the platform and objectives associated with the new data records or tokens, such as encouraging invention and/or corporations to provide separate value to the inventors even after the invention is assigned.

In another example, the objective of establishing value may be the inventor promoting inventions on the global platform, such as by promoting using hashtags. The notion of tokens in one embodiment also includes a measurement or representation of value (including a designation that may be converted to financial value, as described in the provisional titled “Hashtags as Tokens in Blockchain-based Social Networks”, U.S. Provisional Pat. Ser. No. 62/815,994, incorporated by reference in full and its entirety as if fully presented herein.

Computing Environment

This disclosure is directed to a system and method of creating or processing a new data record associated with inventorship value. This disclosure also is directed generating analytics based on the data received regarding the new data record during its creation or processing.

In one example, an additional advantage of the creation and processing of the new data record is that a portion or the full processing of any hardware, software and/or a combination of hardware and software components or portions of the processing, can be performed on a variety of hardware and/or software resources. In addition, the hardware and/or software resources can support portions of processing in a distributed network approach. As a result, computationally intensive processing need not be executed entirely on any single device, or by the server(s) and processor(s) associated with a single platform or other environments, but portions of the creation or processing can be performed on one of application servers as well as other servers, such as the mobile or web platform server(s) which are remote from the mobile or web platform application(s). Portions of the processing can also be distributed to applications or servers with portions or all the processing components being remote from each other. In addition, processing loads can be distributed across several servers. Processing loads, or portions of loads, can also be distributed to additional servers that run related or alternative platforms, either independently, or in conjunction, with the primary processing servers. In this example, the load on any individual device or web platform can be reduced. By distributing the processing load to the one or more platform server(s), the data processing, collection, sorting, filtering, analysis, and storage associated with the creation or processing of new data records can be more effectively managed. The impact can be an overall reduction in processing loads at any one server or platform associated with the creation or processing of the new data record.

An illustrative computing environment may be traditional computing using hardware and software, client-server computing, peer-to-peer computing, web-based computing, distributed computing environment, etc. Computing environments include one or more applications. The applications can include a variety of applications, including mobile applications, web platform applications API application, cloud computing and virtual computing, as examples. In additional examples, other hardware, software and/or UIs or other components of a variety of applications in other technology environments, as a variety of technology environments are within the scope of the invention.

Mobile devices supporting the applications can be operated on a variety of different operating systems such as iOS, Android, or Windows Mobile, etc., to name a few examples. Web platforms supporting applications can be operated on a variety of different operating systems such as Microsoft Windows, Apple OS X, Linus, Chrome, Firefox, Safari etc., to name a few examples. A variety of operating systems, including hardware and/or software components supporting the applications, or other computer applications or technology platforms or environments in which the conversations appear are within the scope of the instant claims and invention.

While servers from any number of environments can be used, the processing can be implemented in several environments thus the use of platform server(s) is optional. The computing architecture can include one or more processors and one or more computer-readable media that store various modules, applications, programs, or other data. The computer-readable media can include instructions that, when executed by one or more processors, cause the processors to perform the operations described herein. The one or more processors, referred to in the previous example may include any suitable type of processor including, without limitation, central processing units or graphics processing units.

Implementations also can be provided as a computer program product including a non-transitory machine-readable storage medium having stored instructions thereon (in compressed or uncompressed form) that can be used to program a computer (or other electronic device) to perform processes or methods described herein. The machine-readable storage medium can include, but is not limited to, hard drives, floppy diskettes, optical disks, CD-ROMs, DVDs, read-only memories (ROMs), random access memories (RAMs), EPROMs, EEPROMs, flash memory, magnetic or optical cards, solid-state memory devices, or other types of media/machine-readable medium suitable for storing electronic instructions. Further, examples can also be provided as a computer program product including a non-transitory or transitory machine-readable signal (in compressed or uncompressed form). Examples of machine-readable signals, whether modulated using a carrier or not, include, but are not limited to, signals that a computer system or machine hosting or running a computer program can be configured to access, including signals downloaded through the Internet or other networks. In addition, system memory, removable storage, and non-removable storage are all examples of non-transitory computer-readable media. Non-transitory computer-readable storage media may include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other tangible, physical medium which can be used to store the desired information and which can be accessed by the carrier servers.

The disclosure sets forth example embodiments and, as such, is not intended to limit the scope of embodiments of the disclosure and the appended claims in any way. Embodiments have been described above with the aid of functional building blocks illustrating the implementation of specified functions and relationships thereof. The boundaries of these functional building blocks have been arbitrarily defined herein for the convenience of the description. Alternate boundaries can be defined to the extent that the specified functions and relationships thereof are appropriately performed.

The foregoing description of specific embodiments will so fully reveal the general nature of embodiments of the disclosure that others can, by applying knowledge of those of ordinary skill in the art, readily modify and/or adapt for various applications such specific embodiments, without undue experimentation, without departing from the general concept of embodiments of the disclosure. Therefore, such adaptation and modifications are intended to be within the meaning and range of equivalents of the disclosed embodiments, based on the teaching and guidance presented herein. The phraseology or terminology herein is for the purpose of description and not of limitation, such that the terminology or phraseology of the specification is to be interpreted by persons of ordinary skill in the relevant art in light of the teachings and guidance presented herein.

The breadth and scope of embodiments of the disclosure should not be limited by any of the above-described example embodiments, but should be defined only in accordance with the following claims and their equivalents.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language generally is not intended to imply that features, elements, and/or operations are in any way required for one or more implementations or that one or more implementations necessarily include logic for deciding, with or without user input or prompting, whether these features, elements, and/or operations are included or are to be performed in any particular implementation.

The specification and annexed drawings disclose examples of systems, apparatus, devices, and techniques that may provide control and optimization of separation equipment. It is, of course, not possible to describe every conceivable combination of elements and/or methods for purposes of describing the various features of the disclosure, but those of ordinary skill in the art recognize that many further combinations and permutations of the disclosed features are possible. Accordingly, various modifications may be made to the disclosure without departing from the scope or spirit thereof. Further, other embodiments of the disclosure may be apparent from consideration of the specification and annexed drawings, and practice of disclosed embodiments as presented herein. Examples put forward in the specification and annexed drawings should be considered, in all respects, as illustrative and not restrictive. Although specific terms are employed herein, they are used in a generic and descriptive sense only, and not used for purposes of limitation.

Those skilled in the art will appreciate that, in some implementations, the functionality provided by the processes and systems discussed above may be provided in alternative ways, such as being split among more software programs or routines or consolidated into fewer programs or routines. Similarly, in some implementations, illustrated processes and systems may provide more or less functionality than is described, such as when other illustrated processes instead lack or include such functionality respectively, or when the amount of functionality that is provided is altered. In addition, while various operations may be illustrated as being performed in a particular manner (e.g., in serial or in parallel) and/or in a particular order, those skilled in the art will appreciate that in other implementations the operations may be performed in other orders and in other manners. Those skilled in the art will also appreciate that the data structures discussed above may be structured in different manners, such as by having a single data structure split into multiple data structures or by having multiple data structures consolidated into a single data structure. Similarly, in some implementations, illustrated data structures may store more or less information than is described, such as when other illustrated data structures instead lack or include such information respectively, or when the amount or types of information that is stored is altered. The various methods and systems as illustrated in the figures and described herein represent example implementations. The methods and systems may be implemented in software, hardware, or a combination thereof in other implementations. Similarly, the order of any method may be changed and various elements may be added, reordered, combined, omitted, modified, etc., in other implementations.

From the foregoing, it will be appreciated that, although specific implementations have been described herein for purposes of illustration, various modifications may be made without deviating from the spirit and scope of the appended claims and the elements recited therein. In addition, while certain aspects are presented below in certain claim forms, the inventors contemplate the various aspects in any available claim form. For example, while only some aspects may currently be recited as being embodied in a particular configuration, other aspects may likewise be so embodied. Various modifications and changes may be made as would be obvious to a person skilled in the art having the benefit of this disclosure. It is intended to embrace all such modifications and changes and, accordingly, the above description is to be regarded in an illustrative rather than a restrictive sense.

What is claimed is:

1. A system, comprising:
one or more processors; and
memory storing computer-executable instructions that, when executed by the one or more processors, cause the one or more processor to perform acts to:
receive, from a client device associated with an inventor, a first inventor record including one or more patents for which the inventor is listed as an inventor;
receive ownership data associated with the inventorship record;
determine, based at least in part on the ownership data and the inventorship record, an inventorship value; and
store, as a data record, the inventorship value.

2. The system as in claim 1, wherein the instructions further cause the one or more processors to determine, based at least in part on the first inventor record, a financial benefit to an assignee resulting from the patent.

3. The system as in claim 1, wherein the instructions further cause the one or more processors to determine, based at least in part on one or more objective factors, a change to the value of the patent.

4. The system as in claim 1, wherein the one or more objective factors include one or more of a number of patents for which the inventor is listed, a valuation of the patent, a revenue resulting from the patent, or an adjudication of the patent.

5. The system as in claim 4, wherein the instructions further cause the one or more processors to determine a second inventorship value based at least in part upon the one or more objective factors and store the second inventorship value.

6. A method, comprising:
determine at least one patent;
determine at least one inventor of the at least one patent;
create an inventorship value record based at least in part on one or more objective factors, the one or more objective factors including a valuation of the patent, a revenue resulting from the patent, a revenue associated with the patent, a valuation event associated with the inventor, a revenue event associated with the inventor, a reputation of the inventor, a revenue associated with the patent, a revenue realized from the patent, a revenue associated with an event in the technology industry associated with the patent, a financial transaction associated with the patent, market data associated with the patent, or an adjudication of the patent; and
associate the inventorship value record with the inventor.

7. The method of claim 6, further comprising determine the assignee of the at least one patent, and wherein the one or more objective factors further comprise a revenue associated with the assignee, a valuation of the assignee, an event associated with the assignee, a financial transaction associated with the assignee, market data associated with the assignee, a technology maturity of a technology associated with the patent, or an adjudication associated with eh assignee.

8. The method of claim 7, wherein the assignee is different than the inventor.

9. The method of claim 7, wherein the assignee includes a plurality of entities, and the inventor is different than at least one of the plurality of entities.

10. The method of claim 8, wherein the one or more objective factors further comprise a change to the assignee, and further comprising:
determine a new assignee of the at least one patent, the new assignee being different than the inventor; and
confirm the association of the inventorship value record with the inventor.

11. The method of claim 6, further comprising:
determine a change to at least one of the one or more of the objective factors;
modify, based at least in part on the change to the one or more objective factors, the inventorship value record.

12. The method of claim 11, wherein modify the inventorship value record associated with the inventor occurs at a first time, and further comprising:
determine a second change to at least one of the one or more of the objective factors;
updating the inventorship value record associated with inventor at a second time, later than the first time, based on the second change to the at least one of the one or more objective factors.

13. A method, comprising:
determining an inventor of a patent;
determining an economic value of the patent;
generating an inventorship value; and
associating the inventorship value with the inventor.

14. The method as in claim 13, further comprising determining one or more objective factors and updating the inventorship value based on the one or more objective factors.

15. The method as in claim 14, wherein the one or more objective factors comprise market data, a technology maturity, a valuation of the patent, a revenue realized from the patent, metrics associated with an inventor of the patent, an adjudication of the patent, or a reputation of the inventor.

16. The method as in claim 13, further comprising paying, to an inventor associated with the inventorship value, remuneration based at least in part on the inventorship value.

17. The method as in claim 13, wherein creating the data record comprises assigning a token to the data record.

18. The method as in claim 17, wherein the token comprises a blockchain.

19. The method as in claim 13, further comprising establishing a financial repository for remunerating inventorship value.

20. The method as in claim 13, further comprising tracking the inventorship value over time and modifying, based at least in part on tracking the inventorship value over time, the data record to reflect the inventorship value.
